(19) United States
(12) Patent Application Publication
(10) Pub. No.: US 2022/0123279 A1
(43) Pub. Date: Apr. 21, 2022

(54) SELF-LITHIATING BATTERY CELLS AND METHODS FOR PRE-LITHIATING THE SAME

(71) Applicant: GM GLOBAL TECHNOLOGY OPERATIONS LLC, Detroit, MI (US)

(72) Inventors: Leng Mao, Troy, MI (US); Jeffrey D. Cain, Royal Oak (US); Anil K. Sachdev, Rochester Hills (US); Andrew C. Bobel, Troy, MI (US)

(21) Appl. No.: 17/071,118

(22) Filed: Oct. 15, 2020

(51) Int. Cl. H01M 4/134; H01M 4/62; H01M 4/505; H01M 4/46

(52) U.S. Cl. CPC H01M 4/134; H01M 4/625; H01M 2004/027; H01M 4/466; H01M 4/505

(57) ABSTRACT

Self-lithiating battery cells include an anode having a current collector, a host material applied to the current collector comprising graphite, silicon particles, and/or SiOₓ particles, wherein x is less than or equal to 2, and lithium foil in contact with the current collector. Methods for pre-lithiating battery cells include charging and discharging the battery cell to deplete the lithium foil by causing lithium ions to migrate from the lithium foil to the cathode and/or the anode. The methods can further include subsequently iteratively charging and discharging the battery while the depleted lithium foil remains within the battery cell. The lithium foil can be pure elemental lithium metal or a lithium magnesium alloy. The lithium foil can include 10 wt. % to 99 wt. % lithium and 1 wt. % to 90 wt. % magnesium. The anode current collector can include perforations.

### INTRODUCTION

Lithium ion batteries describe a class of rechargeable batteries in which lithium ions move between a negative electrode (i.e., anode) and a positive electrode (i.e., cathode). Liquid, solid, and polymer electrolytes can facilitate the movement of lithium ions between the anode and cathode. Lithium-ion batteries are growing in popularity for defense, automotive, and aerospace applications due to their high energy density and ability to undergo successive charge and discharge cycles.

### SUMMARY

Provided are methods for pre-lithiating a battery cell. The methods can include providing a battery cell which includes a cathode electrically connected to an anode by an interruptible external circuit. The anode includes a current collector, a host material applied to the current collector and comprising graphite, silicon particles, and/or SiOₓ particles, wherein x is less than or equal to 2, and lithium foil in contact with the current collector. The method further includes charging the battery cell and discharging the battery cell to deplete the lithium foil by causing lithium ions to migrate from the lithium foil to the cathode and/or the anode. The methods can further include subsequently iteratively charging and discharging the battery while the depleted lithium foil remains within the battery cell. The lithium foil can be pure elemental lithium metal. The lithium foil can be a lithium-magnesium alloy or a lithium-zinc alloy. The lithium foil can include 10 wt. % to 99 wt. % lithium and 1 wt. % to 90 wt. % magnesium. The anode can include two anode current collectors each having an inner face and an outer face, and the lithium foil can be disposed contiguous with the inner face of each anode current collector and the host material is applied to the outer face of each anode current collector. The host material can be applied to the anode current collector such that one or more regions of the anode current collector remain uncoated, and the lithium foil can be positioned contiguous with the one or more uncoated regions of the anode current collector. The anode current collector can include perforations.

Also provided are self-lithiating battery cells, which can include a cathode electrically connected to an anode by an interruptible external circuit. The anode can include a current collector, a host material applied to the current collector and comprising graphite, silicon particles, and/or SiOₓ particles, wherein x is less than or equal to 2, and lithium foil in contact with the current collector. The self-lithiating battery cells, upon iterative charging and discharging, can include a depleted lithium foil within the battery cell. The lithium foil can be pure elemental lithium metal. The lithium foil can be a lithium-magnesium alloy or a lithium-zinc alloy. The lithium foil can include 10 wt. % to 99 wt. % lithium and 1 wt. % to 90 wt. % magnesium. The anode can include two anode current collectors each having an inner face and an outer face, and the lithium foil can be disposed contiguous with the inner face of each anode current collector and the host material is applied to the outer face of each anode current collector. The host material can be applied to the anode current collector such that one or more regions of the anode current collector remain uncoated, and the lithium foil can be positioned contiguous with the one or more uncoated regions of the anode current collector. The anode current collector can include perforations.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a lithium battery cell, according to one or more embodiments;

FIG. 2 illustrates a schematic diagram of a hybrid-electric vehicle, according to one or more embodiments;

FIG. 3A illustrates a schematic diagram of a self-lithiating battery cell charging, according to one or more embodiments;

FIG. 3B illustrates a schematic diagram of a self-lithiating battery cell discharging, according to one or more embodiments;

FIG. 4A illustrates a schematic diagram of a self-lithiating battery cell charging, according to one or more embodiments; and

FIG. 4B illustrates a schematic diagram of a self-lithiating battery cell discharging, according to one or more embodiments;

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are self-lithiating battery cells methods for lithiating the same. The battery cells disclosed herein use lithium-based foils in contact with anode current collectors in a conventional lithium ion battery which obviate the need for a third electrode per battery cell and/or costly and burdensome pre-lithiation methods. The battery cells and methods provided herein minimize or eliminate low initial coulombic efficiency, inferior long-term cycling performance, and low energy density of battery cells.

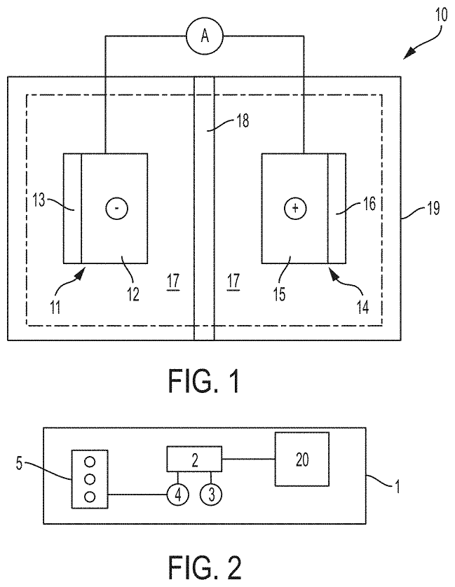

FIG. 1 illustrates a lithium battery cell 10 comprising a negative electrode (i.e., the anode) 11, a positive electrode (i.e., the cathode) 14, an electrolyte 17 operatively disposed between the Anode 11 and the cathode 14, and a separator 18. Anode 11, cathode 14, and electrolyte 17 can be encapsulated in container 19, which can be a hard (e.g., metallic) case or soft (e.g., polymer) pouch, for example. The Anode 11 and cathode 14 are situated on opposite sides of separator 18 which can comprise a microporous polymer or other suitable material capable of conducting lithium ions and optionally electrolyte (i.e., liquid electrolyte). Electrolyte 17 is a liquid electrolyte comprising one or more lithium salts dissolved in a non-aqueous solvent. Anode 11 generally includes a current collector 12 and a lithium intercalation host material 13 applied thereto. Cathode 14 generally includes a current collector 15 and a lithium-based active material 16 applied thereto. For example, the battery cell 10 can comprise a lithium metal oxide active material 16, among many others, as will be described below. Active material 16 can store lithium ions at a higher electric potential than intercalation host material 13, for example. The current collectors 12 and 15 associated with the two electrodes are connected by an interruptible external circuit that allows an electric current to pass between the electrodes to electrically balance the related migration of lithium ions. Although FIG. 1 illustrates host material 13 and active material 16 schematically for the sake of clarity, host material 13 and active material 16 can comprise an exclusive interface between the anode 11 and cathode 14, respectively, and electrolyte 17.

Battery cell 10 can be used in any number of applications. For example, FIG. 2 illustrates a schematic diagram of a hybrid-electric vehicle 1 including a battery pack 20 and related components. A battery pack such as the battery pack 20 can include a plurality of battery cells 10. A plurality of battery cells 10 can be connected in parallel to form a group, and a plurality of groups can be connected in series, for example. One of skill in the art will understand that any number of battery cell connection configurations are practicable utilizing the battery cell architectures herein disclosed, and will further recognize that vehicular applications are not limited to the vehicle architecture as described. Battery pack 20 can provide energy to a traction inverter 2 which converts the direct current (DC) battery voltage to a three-phase alternating current (AC) signal which is used by a drive motor 3 to propel the vehicle 1. An engine 5 can be used to drive a generator 4, which in turn can provide energy to recharge the battery pack 20 via the inverter 2. External (e.g., grid) power can also be used to recharge the battery pack 20 via additional circuitry (not shown). Engine 5 can comprise a gasoline or diesel engine, for example.

Battery cell 10 generally operates by reversibly passing lithium ions between Anode 11 and cathode 14. Lithium ions move from cathode 14 to Anode 11 while charging, and move from Anode 11 to cathode 14 while discharging. At the beginning of a discharge, Anode 11 contains a high concentration of intercalated/alloyed lithium ions while cathode 14 is relatively depleted, and establishing a closed external circuit between Anode 11 and cathode 14 under such circumstances causes intercalated/alloyed lithium ions to be extracted from Anode 11. The extracted lithium atoms are split into lithium ions and electrons as they leave an intercalation/alloying host at an electrode-electrolyte interface. The lithium ions are carried through the micropores of separator 18 from Anode 11 to cathode 14 by the ionically conductive electrolyte 17 while, at the same time, the electrons are transmitted through the external circuit from Anode 11 to cathode 14 to balance the overall electrochemical cell. This flow of electrons through the external circuit can be harnessed and fed to a load device until the level of intercalated/alloyed lithium in the negative electrode falls below a workable level or the need for power ceases.

Battery cell 10 may be recharged after a partial or full discharge of its available capacity. To charge or re-power the lithium ion battery cell, an external power source (not shown) is connected to the positive and the negative electrodes to drive the reverse of battery discharge electrochemical reactions. That is, during charging, the external power source extracts the lithium ions present in cathode 14 to produce lithium ions and electrons. The lithium ions are carried back through the separator by the electrolyte solution, and the electrons are driven back through the external circuit, both towards Anode 11. The lithium ions and electrons are ultimately reunited at the negative electrode, thus replenishing it with intercalated/alloyed lithium for future battery cell discharge.

Lithium ion battery cell 10, or a battery module or pack comprising a plurality of battery cells 10 connected in series and/or in parallel, can be utilized to reversibly supply power and energy to an associated load device. Lithium ion batteries may also be used in various consumer electronic devices (e.g., laptop computers, cameras, and cellular/smart phones), military electronics (e.g., radios, mine detectors, and thermal weapons), aircrafts, and satellites, among others. Lithium ion batteries, modules, and packs may be incorporated in a vehicle such as a hybrid electric vehicle (HEV), a battery electric vehicle (BEV), a plug-in HEV, or an extended-range electric vehicle (EREV) to generate enough power and energy to operate one or more systems of the vehicle. For instance, the battery cells, modules, and packs may be used in combination with a gasoline or diesel internal combustion engine to propel the vehicle (such as in hybrid electric vehicles), or may be used alone to propel the vehicle (such as in battery powered vehicles).

Returning to FIG. 1, electrolyte 17 conducts lithium ions between anode 11 and cathode 14, for example during charging or discharging the battery cell 10. The electrolyte 17 comprises one or more solvents, and one or more lithium salts dissolved in the one or more solvents. Suitable solvents can include cyclic carbonates (ethylene carbonate, propylene carbonate, butylene carbonate), acyclic carbonates (dimethyl carbonate, diethyl carbonate, ethylmethylcarbonate), aliphatic carboxylic esters (methyl formate, methyl acetate, methyl propionate), γ-lactones (γ-butyrolactone, γ-valerolactone), chain structure ethers (1,3-dimethoxypropane, 1,2-dimethoxyethane (DME), 1-2-diethoxyethane, ethoxymethoxyethane), cyclic ethers (tetrahydrofuran, 2-methyltetrahydrofuran, 1,3-dioxolane), and combinations thereof. A non-limiting list of lithium salts that can be dissolved in the organic solvent(s) to form the non-aqueous liquid electrolyte solution include LiClO₄, LiAlCl₄, LiI, LiBr, LiSCN, LiBF₄, LiB(C₆H₅)₄LiAsF₆, LiCF₃SO₃, LiN(CF₃SO₂)₂, LiN(FSO₂)₂, LiPF₆, and mixtures thereof.

The microporous polymer separator 18 can comprise, in one embodiment, a polyolefin. The polyolefin can be a homopolymer (derived from a single monomer constituent) or a heteropolymer (derived from more than one monomer constituent), either linear or branched. If a heteropolymer derived from two monomer constituents is employed, the polyolefin can assume any copolymer chain arrangement including those of a block copolymer or a random copolymer. The same holds true if the polyolefin is a heteropolymer derived from more than two monomer constituents. In one embodiment, the polyolefin can be polyethylene (PE), polypropylene (PP), or a blend of PE and PP. The microporous polymer separator 18 may also comprise other polymers in addition to the polyolefin such as, but not limited to, polyethylene terephthalate (PET), polyvinylidene fluoride (PVdF), and or a polyamide (Nylon). Separator 18 can optionally be ceramic-coated with materials including one or more of ceramic type aluminum oxide (e.g., Al₂O₃), and lithiated zeolite-type oxides, among others. Lithiated zeolite-type oxides can enhance the safety and cycle life performance of lithium ion batteries, such as battery cell 10. Skilled artisans will undoubtedly know and understand the many available polymers and commercial products from which the microporous polymer separator 18 may be fabricated, as well as the many manufacturing methods that may be employed to produce the microporous polymer separator 18.

Active material 16 can include any lithium-based active material that can sufficiently undergo lithium intercalation and deintercalation while functioning as the positive terminal of battery cell 10. Active material 16 can also include a polymer binder material to structurally hold the lithium-based active material together. The active material 16 can comprise lithium transition metal oxides (e.g., layered lithium transitional metal oxides). Cathode current collector 15 can include aluminum or any other appropriate electrically conductive material known to skilled artisans, and can be formed in a foil or grid shape. Cathode current collector 15 can be treated (e.g., coated) with highly electrically conductive materials, including one or more of conductive carbon black, graphite, carbon nanotubes, carbon nanofiber, graphene, and vapor growth carbon fiber (VGCF), among others. The same highly electrically conductive materials can additionally or alternatively be dispersed within the host material 13.

Lithium transition metal oxides suitable for use as active material 16 can comprise one or more of spinel lithium manganese oxide (LiMn₂O₄), lithium cobalt oxide (LiCoO₂), a nickel-manganese oxide spinel (Li(Ni_{0.5}Mn_{1.5})O₂), a layered nickel-manganese-cobalt oxide (having a general formula of xLi₂MnO₃.(1-x)LiMO₂, where M is composed of any ratio of Ni, Mn and/or Co). A specific example of the layered nickel-manganese oxide spinel is xLi₂MnO₃.(1−x)Li(Ni_{1/3}Mn_{1/3}Co_{1/3})O₂. Other suitable lithium-based active materials include Li(Ni_{1/3}Mn_{1/3}Co_{1/3})O₂), LiNiO₂, Li_{x+y}Mn_{2-y}O₄ (LMO, 0<x<1 and 0<y<0.1), or a lithium iron polyanion oxide, such as lithium iron phosphate (LiFePO₄) or lithium iron fluorophosphate (Li₂FePO₄F). Other lithium-based active materials may also be utilized, such as LiNiₓM₁₋ₓO₂ (M is composed of any ratio of Al, Co, and/or Mg), LiNi₁₋ₓCo_{1-y}Mn_{x+y}O₂ or LiMn_{1.5-x}Ni_{0.5-y}M_{x+y}O₄ (M is composed of any ratio of Al, Ti, Cr, and/or Mg), stabilized lithium manganese oxide spinel (LiₓMn_{2-y}M_{y}O₄, where M is composed of any ratio of Al, Ti, Cr, and/or Mg), lithium nickel cobalt aluminum oxide (e.g., LiNi_{0.8}Co_{0.15}Al_{0.05}O₂ or NCA), aluminum stabilized lithium manganese oxide spinel (LiₓMn₂₋ₓAl_{y}O₄), lithium vanadium oxide (LiV₂O₅), Li₂MSiO₄ (M is composed of any ratio of Co, Fe, and/or Mn), and any other high efficiency nickel-manganese-cobalt material (HE-NMC, NMC or LiNiMnCoO₂). By “any ratio” it is meant that any element may be present in any amount. So, for example, M could be Al, with or without Co and/or Mg, or any other combination of the listed elements. In another example, anion substitutions may be made in the lattice of any example of the lithium transition metal based active material to stabilize the crystal structure. For example, any 0 atom may be substituted with an F atom.

The anode current collector 12 can include copper, aluminum, stainless steel, or any other appropriate electrically conductive material known to skilled artisans. Anode current collector 12 can be treated (e.g., coated) with highly electrically conductive materials, including one or more of conductive carbon black, graphite, carbon nanotubes, carbon nanofiber, graphene, and vapor growth carbon fiber (VGCF), among others. The host material 13 applied to the anode current collector 12 can include any lithium host material that can sufficiently undergo lithium ion intercalation, deintercalation, and alloying, while functioning as the negative terminal of the lithium ion battery 10. Host material 13 can optionally further include a polymer binder material to structurally hold the lithium host material together. For example, in one embodiment, host material 13 can include a carbonaceous material (e.g., graphite) and/or one or more of binders (e.g., polyvinyldiene fluoride (PVdF), an ethylene propylene diene monomer (EPDM) rubber, carboxymethoxyl cellulose (CMC), and styrene, 1,3-butadiene polymer (SBR)), among others known in the art.

Silicon has the highest known theoretical charge capacity for lithium, making it one of the most promising anode host materials 13 for rechargeable lithium-ion batteries. In two general embodiments, a silicon host material 13 can comprise Si particles and/or SiOₓ particles. SiOₓ particles, wherein generally x≤2, can vary in composition. In some embodiments, for some SiOₓ particles, x≈1. For example, x can be about 0.9 to about 1.1, or about 0.99 to about 1.01. Within a body of SiOₓ particles, SiO₂ and/or Si domains may further exist. Silicon host material 13 comprising Si particles or SiOₓ particles can comprise average particle diameters of about 20 nm to about 20 μm, among other possible sizes.

During the first cycling of a “fresh” anode, silicon-based anodes typically exhibit inferior initial coulombic efficiency due to the generally irreversible capture of lithium during the first cycle. For example, in a silicon electrode, a solid electrolyte interface (SEI) layer can form on the host material 13 and capture lithium. In another example, in a SiOₓ electrode, lithium can become irreversibly captured through the formation of Li₄SiO₄ and/or Li₂O within the host material 13. In either instance, the poor initial coulombic efficiency resulting from the inability of lithium to transport back to the cathode 14 can require excessive lithium loading of cathode active material 16 to compensate for the lithium consumed by the anode 11 during the first cycle, which detrimentally reduces the energy density of the battery cell 10.

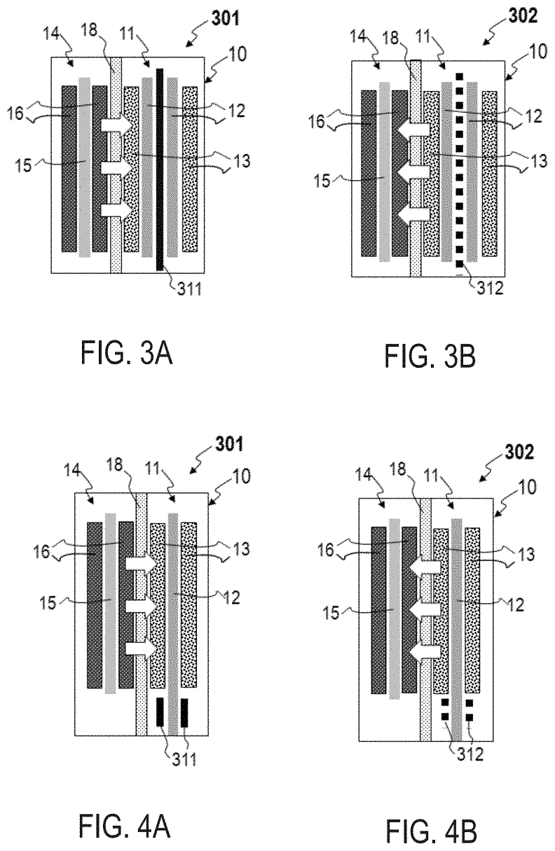

Accordingly, provided herein are self-lithiating battery cells and methods for lithiating the same. The battery cells and methods provide anodes and battery cells which exhibit high initial coulombic efficiency and generally increase the performance of battery cells. The methods will be described in relation to the battery cell 10 of FIGS. 3A-B and 4A-B for the purpose of clarity only, and one of skill in the art will understand that such methods are not intended to be limited thereby. In reference to FIGS. 3A-B and 4A-B, a method for pre-lithiating a battery cell includes providing a battery cell including a cathode 14 electrically connected to an anode 10 by an interruptible external circuit (shown in FIG. 1), wherein the anode 11 comprises a current collector 12, a host material 13 applied to the current collector 12 and lithium foil 311 in contact with the current collector 11; charging 301 the battery cell 10; and discharging 302 the battery cell 10. In FIGS. 3A and 4A the white arrows depict the migration of lithium ions from the cathode 14 to the anode 11 during charging 301. In FIGS. 3B and 4B the white arrows depict the migration of lithium ions from the lithium foil 311 and the anode 11 to the cathode, leaving a depleted lithium foil 312 in the anode. The depleted lithium foil 312 can include some lithium proximate to the original location of the lithium foil 311 (i.e., lithium which has not migrated elsewhere in the battery cell 10), or substantially no lithium proximate to the original location of the lithium foil 311 (i.e., substantially all lithium present in the lithium foil 311 has migrated elsewhere in the battery cell 10). As described above the host material 13 can comprise silicon particles or SiOₓ particles, wherein x is less than or equal to 2. The host material 13 can comprise graphite and one or more of silicon particles and SiOₓ particles in some embodiments.

During initial cycling of lithium ion batteries with silicon-based anodes the latter are lithiated by the cathode during charging, but not all lithium is returned to the cathode during subsequent discharge cycles. In the present disclosure, the lithium lost by the cathode 14 during initial charging is compensated during discharge by the lithium present in the lithium foil, which serves as a lithium reservoir. Pre-lithiation as conducted during charging 301 and discharging 302 can be conducted in iterative charge/discharge cycles by controlling the voltage window to avoid lithium plating and to ensure depletion of lithium from the lithium foil 311. Accordingly, the amount of lithium foil 311 can be tailored to the amount of lithium needed to resupply the cathode 14.

In some embodiments the lithium foil 311 comprises pure (e.g., >95% pure) elemental lithium, or a lithium alloy, among other bulk sources of lithium. The lithium foil 311 can take the form of a plate, thin foil, or other suitable configuration. In particular, the lithium foil 311 can comprise a lithium-magnesium alloy or a lithium-zinc alloy. A lithium-magnesium alloy can comprise lithium, magnesium, and optionally impurities. For example, a lithium-magnesium alloy can comprise 10 wt. % to 99 wt. % lithium and 1 wt. % to 99 wt. % magnesium, 50 wt. % to 99 wt. % lithium and 1 wt. % to 50 wt. % magnesium, or 65 wt. % to 99 wt. % lithium and 1 wt. % to 35 wt. % magnesium. All such alloys can optionally further include less than 2 wt. %, less than 0.5 wt. %, or less than 0.1 wt. % impurities. In such embodiments, the depleted lithium foil 312 comprises a magnesium skeleton which persists throughout the life of the battery. The weight added to the cell by the magnesium skeleton can be considered negligible relative to the pre-lithiation benefits of the lithium foil 311, and further lithium-magnesium alloys are advantageously highly stable in most manufacturing environments.

As shown in FIGS. 3A-B, the anode 11 can comprise two anode current collectors 12 each having an inner face and an outer face with the lithium foil 311 disposed contiguous with the inner face of each anode current collector 12 and the host material 13 applied to the outer face of each anode current collector 12. As shown in FIGS. 4A-B, additionally or alternatively, the host material 13 can be applied to the anode current collector 12 such that one or more regions of the anode current collector remain uncoated, and the lithium foil 311 can be positioned contiguous with the one or more uncoated regions of the anode current collector 12. In either embodiment, and others, the lithium foil 311 is ideally restrained from contacting the host material 13. In some embodiments the anode current collector(s) comprise perforations to increase the lithiation kinetics of the battery cell 10.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for pre-lithiating a battery cell, the method comprising:
providing a battery cell including a cathode electrically connected to an anode by an interruptible external circuit, wherein the anode comprises:
a current collector,
a host material applied to the current collector and comprising graphite, silicon particles, and/or SiOₓ particles, wherein x is less than or equal to 2, and
lithium foil in contact with the current collector;
charging the battery cell; and
discharging the battery cell to deplete the lithium foil by causing lithium ions to migrate from the lithium foil to the cathode and/or the anode.

2. The method of claim 1, further comprising subsequently iteratively charging and discharging the battery while the depleted lithium foil remains within the battery cell.

3. The method of claim 1, wherein the lithium foil comprises pure elemental lithium metal.

4. The method of claim 1, wherein the lithium foil comprises a lithium-magnesium alloy or a lithium-zinc alloy.

5. The method of claim 4, wherein the lithium foil comprises 10 wt. % to 99 wt. % lithium and 1 wt. % to 90 wt. % magnesium.

6. The method of claim 1, wherein the anode comprises two anode current collectors each having an inner face and an outer face, and the lithium foil is disposed contiguous with the inner face of each anode current collector and the host material is applied to the outer face of each anode current collector.

7. The method of claim 1, wherein the host material is applied to the anode current collector such that one or more regions of the anode current collector remain uncoated, and the lithium foil is positioned contiguous with the one or more uncoated regions of the anode current collector.

8. The method of claim 1, wherein the anode current collector comprises perforations.

9. A self-lithiating battery cell comprising:
a cathode electrically connected to an anode by an interruptible external circuit, wherein the anode comprises:
a current collector,
a host material applied to the current collector and comprising graphite, silicon particles, and/or SiOₓ particles, wherein x is less than or equal to 2, and
lithium foil in contact with the current collector.

10. The self-lithiating battery cell of claim 9, further comprising, upon iterative charging and discharging, a depleted lithium foil within the battery cell.

11. The self-lithiating battery cell of claim 9, wherein the lithium foil comprises pure elemental lithium metal.

12. The self-lithiating battery cell of claim 9, wherein the lithium foil comprises a lithium magnesium alloy or a lithium-zinc alloy.

13. The self-lithiating battery cell of claim 12, wherein the lithium foil comprises 10 wt. % to 99 wt. % lithium and 1 wt. % to 90 wt. % magnesium.

14. The self-lithiating battery cell of claim 9, wherein the anode comprises two anode current collectors each having an inner face and an outer face, and the lithium foil is disposed contiguous with the inner face of each anode current collector and the host material is applied to the outer face of each anode current collector.

15. The self-lithiating battery cell of claim 9, wherein the host material is applied to the anode current collector such that one or more regions of the anode current collector remain uncoated, and the lithium foil is positioned contiguous with the one or more uncoated regions of the anode current collector.

16. The self-lithiating battery cell of claim 9, wherein the anode current collector comprises perforations.
